(19) United States
(12) Patent Application Publication
(10) Pub. No.: US 2011/0140862 A1
(43) Pub. Date: Jun. 16, 2011

(54) Technique For Effectively Realizing A Network Of Sensors And Services Thereby

(75) Inventor: Michael Wengrovitz, Concord, MA (US)

(73) Assignee: Alcatel-Lucent USA Inc., Murray Hill, NJ (US)

(21) Appl. No.: 12/636,887

(22) Filed: Dec. 14, 2009

(51) Int. Cl. H04Q 5/22

(52) U.S. Cl. 340/10.4

(57) ABSTRACT

In a telephonic system, a multiplicity of telephonic devices are connected through a telephone network. Each telephonic device incorporates therein a radio frequency identification (RFID) sensor capable of reading data from an RFID tag, e.g., a tag ID. The telephonic device sends the tag ID, and a reader ID identifying the RFID sensor through the network for an RFID application based on the tag ID and reader ID.

### FIELD OF THE INVENTION

The invention relates to a networking technique and, more particularly, to a technique for networking sensors and providing services using the network of sensors.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Radio frequency identification (RFID) sensors nowadays are essential in many systems used for identification, tracking of equipment, location-based services, etc. One type of RFID sensor, known as a “near-field-communications (NFC) reader,” generates radio waves, activating a passive RFID tag when brought close to and virtually in contact with the NFC reader. The passive RFID tag which is not battery-powered, when activated by the radio waves, sends to the reader information encoded in the tag's memory, e.g., a tag ID. For example, an employee of a company may use an ID badge incorporating a passive RFID tag to gain entry to a company building. After the employee brings the badge virtually in contact with an NFC reader at an entry door or turnstile, the reader communicates the tag ID, identifying the employee, and its reader ID to a security system which may then determine whether the employee is allowed to enter the building through the door or turnstile. If so, the system may further make available information about the employee's presence, such as in Bldg123, to interested parties.

Another type of RFID sensor, known as an “active tag reader,” interacts with battery-powered active tags or pingers, and similarly transmits the tag ID it read and its reader ID to a system for rendering a specific service. For example, an active pinger may be attached to equipment whose removal to an area is detectable by an active tag reader whose RF field covers that area, which may then inform the system of the latest location of the equipment.

### BRIEF SUMMARY

The invention is premised upon the recognition that in many practical applications involving use of such sensors as RFID sensors, the number of sensors deployed needs to be large in order for the applications to be effective. In addition, each RFID sensor requires power and network connection for transmitting data to a server for providing a certain service. The requirement of networking and powering the number of RFID sensors on the order of 100 or even 1,000 across a wide area campus, which is not unusual, creates a major barrier-to-entry for adoption of RFID technology.

An embodiment of the invention overcomes such a barrier-to-entry by employing a telephonic system which includes a multiplicity of telephonic devices connected to a network. At least one of the telephonic devices comprises a sensor (e.g., an RFID sensor) for reading first data (e.g., a tag ID) from a mobile element (e.g., an RFID tag). A platform (e.g., a PBX) is used for processing telephone calls. Selected ones of the telephone calls are receivable by the at least one telephonic device via the network. An action is taken based on the first data, and second data concerning the sensor (e.g., a reader ID), which are received from the at least one telephonic device via the network.

### BRIEF DESCRIPTION OF THE DRAWINGS

FIG. 1 is a block diagram of an RFID/telephone system in one embodiment of the invention;

FIG. 2 is a block diagram of a telephone used in the system of FIG. 1;

FIG. 3 is a flow chart depicting a routine carried out by the system of FIG. 1; and

FIG. 4 illustrates a graphical user interface (GUI) used in the telephone of FIG. 2.

### DETAILED DESCRIPTION

The invention is premised upon the recognition that in many practical applications involving use of such sensors as RFID sensors, the number of sensors deployed needs to be large in order for the applications to be effective. For example, in order for a system to effectively publish the location of an employee within an office building, not only should there be an NFC reader at each building entrance, but also at each room entrance and/or on each desktop computer. In order for a system to effectively track equipment in a facility, e.g., a hospital, active tag readers should be placed and distributed throughout the facility to achieve, e.g., room-based or hall-based fine-granularity, thereby accurately locating the equipment.

The invention is also premised upon the recognition that each RFID sensor/reader requires power and network connection for transmitting data to a server for providing a certain service. The requirement of networking and powering the number of RFID sensors on the order of 100 or even 1,000 across a wide area campus, which is not unusual, creates a major barrier-to-entry for adoption of RFID technology. This barrier-to-entry could be overwhelming which includes, among other things, detailed power/data network and space planning which at best is time consuming, and physically wiring and pulling long runs of Ethernet cables through walls, ceilings and panels, which are not only time consuming but also disruptive to daily business operation, environmentally unfriendly and costly. An attempt to lessen such a barrier-to-entry may involve use of Wifi backhaul or a Zigbee mesh network for radio-based data telemetry. However, providing electrical supply to hundreds or thousands of RFID sensors across a wide area campus remains a major problem, not to mention installing a vast number of physical mounts for such sensors. Radio-based backhaul may also be impractical in some facilities due to restrictions/regulations, RF congestion and interference, etc.

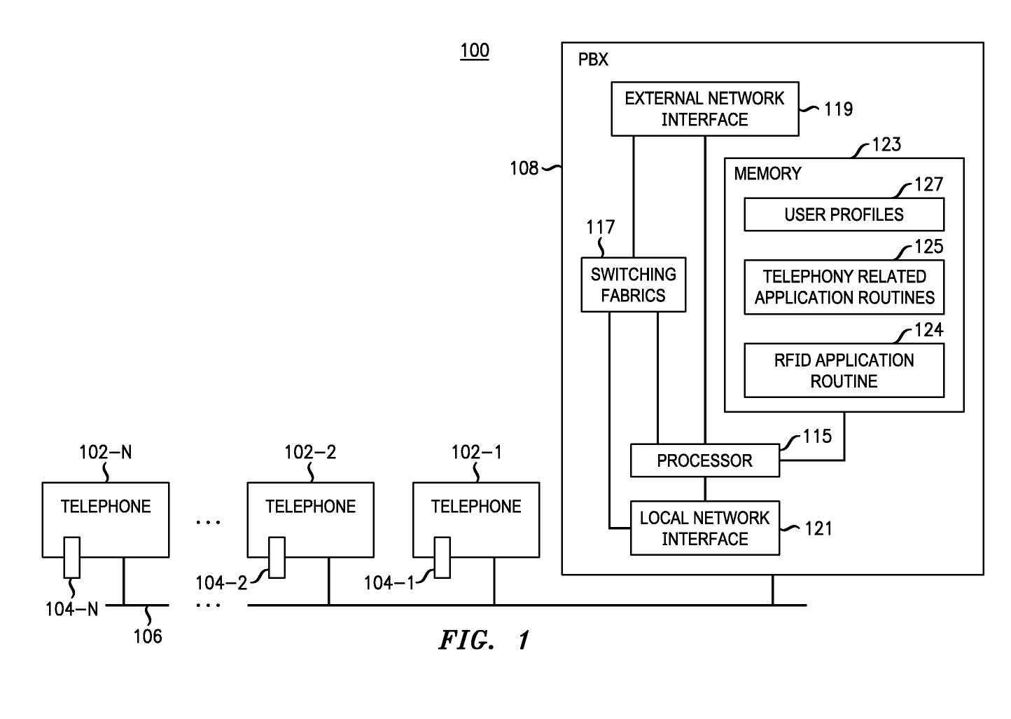

One embodiment of the invention effectively overcomes the aforementioned barrier-to-entry by taking advantage of an existing telephone system in a facility to provide the necessary power, data networking and physical mounts for a multiplicity of RFID sensors. FIG. 1 illustrates an RFID/telephone system 100 embodying the principles of the invention. System 100 is derived from the existing telephone system, and is realized with minimal set-up cost and time. In fact, besides RFID sensors 104-1 through 104-N (generically 104), where N>1, system 100 utilizes virtually the same hardware as the existing telephone system which in this instance includes an Internet protocol (IP) based network 106, e.g., an Ethernet, for connecting hundreds or thousands of conventional telephones throughout a facility, and for transporting power to, and data to and from, these telephones. For example, in system 100 the hardware of telephones 102-1 through 102-N (generically 102) and a telephony switching platform such as private branch exchange (PBX) 108, and the underlying data and power Ethernet connections come from the existing telephone system. However, the software of telephones 102 and PBX 108 in system 100 has been improved over that of the existing system to realize an RFID application, which is to be described.

In this illustrative embodiment, telephone 102 is derived from a conventional IP multimedia phone which provides, among other things, traditional telephony features, secure VoIP SIP functionality, video capability, Internet access, etc. This conventional phone may be regarded as an always-on desktop computing device, incorporating therein, among other things, a CPU, touch screen display, browser-based software, real-time operating system, and universal serial bus (USB) and IP ports. The IP port facilitates connection of the phone, e.g., to a PBX (such as PBX 108 in this instance), or to a service-provider's network using industry standard VoIP protocols, such as SIP. The USB ports allow connections of such external devices as a USB printer, keyboard, mouse and flash drive, to the phone.

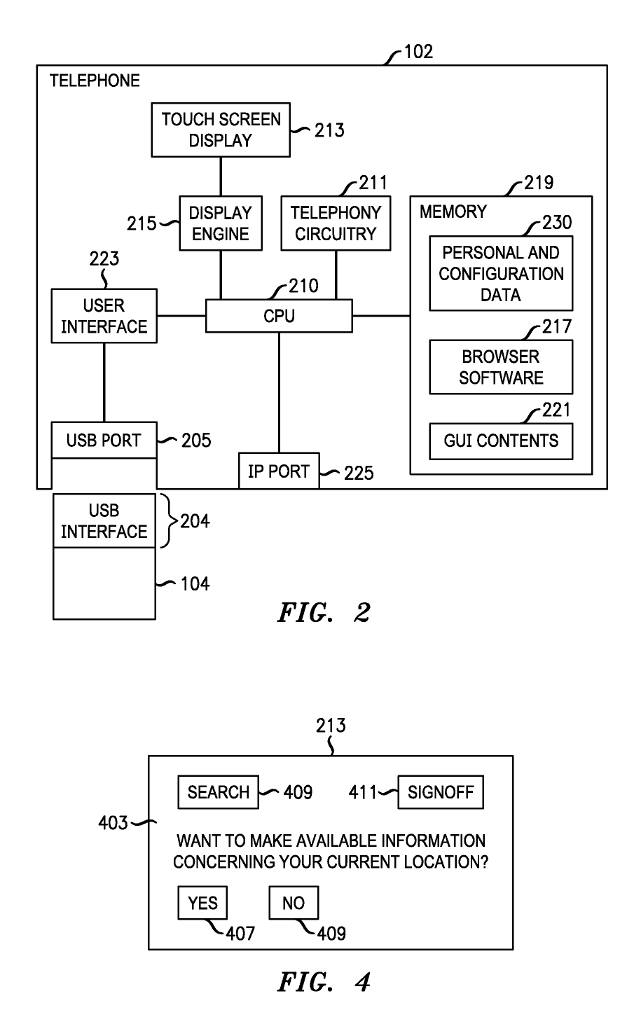

In accordance with an embodiment of the invention, as shown in FIG. 2, one such USB port 205 of telephone 102 is used for connection with an RFID sensor 104. Advantageously, USB port 205 in this embodiment provides for sensor 104 a convenient accommodation, and the necessary power (i.e., USB power) and data networking (i.e., IP connectivity) via network 106. RFID sensor 104 is derived from a conventional RFID sensor and, in this embodiment, includes USB interface 204 which enables RFID sensor 104 to exchange data with, and draw power from, telephone 102 based on a standard USB 1.0/2.0 protocol.

It should be noted that use of a telephone (e.g., 102) as a location-based sensor platform as in system 100 is particularly advantageous in that (1) many such phones are already distributed throughout the facility; (2) no separate/additional wiring for the sensors is required (3) no separate/additional physical mounting of the sensors is required; (4) the phones are always-on; (5) the locations of the phones are fixed, which is important for RFID location-based services; (6) the display on the phone is convenient for user interaction and graphical display; (7) the real-time processor already resident in the phone may be used in lieu of the processor in an RFID sensor, and/or used to reduce IP traffic over network 106; (8) the complexity and cost of an RFID sensor may be substantially reduced as only the basic sensing capability is required of the sensor and the extra cost of having an USB interface (e.g., 204) is minimal; etc.

Referring back to FIG. 1, PBX 108 in system 100 includes processor 115 which performs, among other things, such conventional functions as management and administration of telephone calls to and from telephones 102-1 through 102-N. For example, processor 115 uses well known switching fabrics 117 to switch calls to and from an external network, e.g., the Internet, a PSTN, etc., through external network interface 119. It may also use switching fabrics 117 to switch internals calls among telephones 102, and transfer calls from one telephone to another on network 106. Through local network interface 121, processor 115 also communicates data with telephones 102 via network 106 to realize such well known telephonic functions as call forwarding, teleconferencing, messaging, caller ID, etc. Processor 115 is instructed to perform the aforementioned telephonic functions by well known telephony related application routines 125 stored in memory 123. Also stored in memory 123 are user profiles 127 which are associated with different users of system 100. Each user profile may contain the associated user's personal and preference information, e.g., a PIN for accessing voicemail, personal phone hook, personal phone number, personal greeting, favorite web links, telephone configuration data for personalizing his/her telephone, etc. Processor 115 may also execute RFID application routine 129 stored in memory 123 to realize an RFID application in one embodiment, which is fully described below.

Referring back to FIG. 2, telephone 102 may be a stationary desktop telephonic device, which includes CPU 210 which controls telephony circuitry 211 to perform, among other things, conventional communication functions which enable a user to make and receive phone calls, access messages, speed-dial, teleconference, etc. In this instance, telephone 102 also includes touch-screen display 213 which is driven by display engine 215 which incorporates therein well-known touch-screen circuitry for realizing a touch-screen capability. By CPU 210 running browser software 217 stored in memory 219, a user is able to access and view on display 213 menus and other information based on GUI contents 221, also stored in memory 219, and to browse web information on the Internet. A user may select displayed options and soft-keys on the screen of display 213, which selection is detectable by the touch-screen circuitry in engine 215. CPU 210 determines and carries out the actual selected function based on the selection data from engine 215. CPU 210 also configures aspects of telephone 102 based on personal and configuration data 230 stored in memory 219, which is provided from user profiles 127 in PBX 108. For example, based on data 230, the soft-keys and speed-dial keys on telephone 102 may be reconfigured according to the user preferences previously recorded in the user profile. Data 230 also includes the user's personal phone book and favorite web links accessible to the user on telephone 102.

Telephone 102 is connected to network 106 through IP port 225 using, e.g., a Category 5 (Cat5) cable. As a result, telephone 102 is wired and its location is fixed. User interface 223 in telephone 102 is connected, for example, to a telephone receiver (not shown), a keyboard (not shown), dialing pad (not shown), and other keys (not shown) which enable a user to communicate his/her input to CPU 210 in addition to the touch-screen capability. Interface 223 is also connected to USB port 205 mentioned before. In this instance, RFID sensor 104 described above is connected to port 205 through its USB interface 204 to realize an RFID application, in accordance with routine 129 in PBX 108.

In one embodiment, RFID sensors 104-1 through 104-N in system 100 illustratively are NFC tag readers for carrying out the aforementioned RFID application. Each of such NFC tag reader may be encased in a small plastic box with a short USB cable, as interface 204, connectable to telephone 102. The RFID application in this illustrative embodiment enables “portability” of personal data and telephone configuration from one telephone to another in system 100. In other words, each telephone 102 in system 100 may be treated as a generic phone until the user of the phone is identified, at which time the phone is personalized based on the user's profile.

To illustrate the RFID application in question, let's say system 100 is used in a company, with each of telephones 102-1 through 102-N installed in a different room, which may be a temporary office. Employee A working for the company may utilize one of the rooms, say, Room 123, to conduct company business, where telephone 102-1 is installed. To personalize telephone 102-1, Employee A brings his employee ID badge, incorporating a passive RFID tag therein, in close proximity of RFID sensor 104-1. In a well known manner, sensor 104-1 reads a tag ID encoded in the passive tag, which identifies Employee A. Based on a pre-agreed upon protocol, CPU 210 transmits to PBX 108 through network 106 the tag ID just read, and a reader ID identifying sensor 104-1 and, thus, telephone 102-1 to which sensor 104-1 is connected.

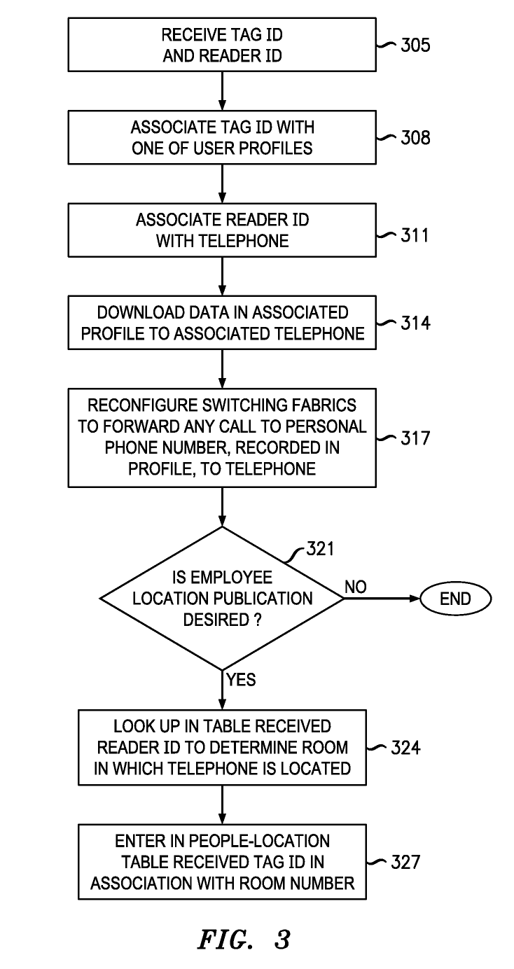

Instructed by RFID application routine 129, processor 115 of PBX 108 receives the tag ID and the reader ID from network 106, as indicated at step 305 in FIG. 3. At step 308, processor 115 associates the tag ID with one of user profiles 127, which belongs to Employee A. At step 311, processor 115 associates the reader ID with telephone 102-1. Processor 115 at step 314 downloads selected data in the associated profile (i.e., Employee A's profile) to the associated telephone (i.e., telephone 102-1) through network 106. Processor 115 at step 317 reconfigures switching fabrics 117 to forward any call to the personal phone number of Employee A, recorded in the associated profile, to the associated telephone.

The selected profile data from PBX 108 is received by telephone 102-1, where CPU 210 stored the data in memory 219 as personal and configuration data 230. Based on data 230, CPU 210 personalizes telephone 102-1 for Employee A, which personalization, as mentioned before, may involve, e.g., reconfiguration of soft-keys and speed-dial keys of telephone 102-1 according to Employee A's preferences. Data 230 may also include Employee A's personal phone book from which a phone number entry may be conveniently selected for calling. Data 230 may further include Employee A's favorite web links, thereby facilitating visits to his/her favorite web pages on the Internet.

At step 321, processor 115 transmits to telephone 102-1 a query whether employee location publication is desired, which is to be answered by Employee A. Telephone 102-1 incorporates the content of the received query into a GUI shown on display 213. FIG. 4 illustrates one such GUI, denoted 403, which includes the query as to whether Employee A wants to make available information concerning his/her current location to interested parties, e.g., security personnel, co-workers, etc. Employee A may respond to the query by touching either Yes option 407 or No option 409 on the display screen. If the response from telephone 102-1 is negative, routine 129 comes to an end. Otherwise, if the response from telephone 102-1 is affirmative, processor 115 at step 324 looks up in a table (not shown) the received reader ID, associated with telephone 102-1, to determine the room in which telephone 102-1 is located (i.e., Room 123 in this instance). Processor 115 at step 327 enters in a people-location table (not shown) the received tag ID, identifying Employee A, in association with the room number.

For example, by selecting a Search option (e.g., 409 in FIG. 4) on the display screen of a telephone in system 100, an interested party may specify a search for the current location of Employee A. Such a search request is then sent from the telephone to PBX 108 where in response processor 115 associates Employee A with his/her tag ID, and looks up in the aforementioned people-location table the associated room number. Processor 115 then returns a response to the search request, including the room number, to the telephone from which the request originated. Also shown on GUI 403 is Signoff option 411, selection of which would cause a reversion of the configuration of telephone 102-1 to its generic configuration, and erasure of the Employee A's location entry in the people-location table in PBX 108.

In another embodiment, each RED sensors 104-1 through 104-N is an active tag reader for tracking equipment (e.g., wheelchairs) in a facility (e.g., a hospital) employing system 100. The active tag reader may be in the form of a dongle-like device attached to the USB port of a corresponding telephone in system 100. A battery-powered active tag or pinger is attached to each wheelchair being tracked. In a well known manner, when the pinger comes within a radiation pattern or field of one of sensors 104-1 through 104-N in system 100, the sensor reads a tag 11) encoded in the pinger, which identifies the wheelchair to which the pinger is attached. CPU 210 of the telephone to which the sensor is connected causes transmission of the tag ID, and a reader ID stored in the sensor to PBX 108, where processor 115 updates a wheelchair-location table (not shown) similarly to the aforementioned people-location table. That is, based on the received reader ID, processor 115 identifies the room where the telephone to which the sensor is connected. Processor 115 then enters the wheelchair-location table the tag ID identifying the wheelchair in association with the room number. Like the people-location table, the wheelchair-location table is searchable for a particular wheelchair using a search capability of a telephone in system 100.

The foregoing merely illustrates the principles of the invention. It will thus be appreciated that those skilled in the art will be able to devise numerous arrangements which embody the principles of the invention and are thus within its spirit and scope.

For example, in one embodiment the RFID sensors used in system 100 are NFC readers, and in another embodiment the RFID sensors used in system 100 are active RFID tag readers. It will be appreciated that a combination of sensors including, but not limited to, the NFC readers and active RFID tag reader may be simultaneously used in the same or different telephones in system 100, in accordance with the principles of the invention.

In addition, in the disclosed embodiment, an RFID application is executed in PBX 108. However, in another embodiment, the RFID application is executed externally to system 100, e.g., on the web or a cloud computing network. For example, upon receipt of a tag ID and reader ID, processor 115 may transmit a web service request to initiate the RFID application, which may be a simple web HTTP GET URL request including the tag ID and reader ID as name/value parameters, or within an XML body of a web service SOAP request.

Further, it will be appreciated that one skilled in the art may take advantage of the CPU capacity of a telephone in system 100 to which a RFID sensor is connected to perform RFID-related processing and/or filtering, in addition to transmitting of tag IDs and reader IDs. For example, CPU 210 may help selectively initiate an RFID application to reduce traffic on network 106.

Finally, although system 100, as disclosed, is embodied in the form of various discrete functional blocks, such a system could equally well be embodied in an arrangement in which the functions of any one or more of those blocks or indeed, all of the functions thereof, are realized, for example, by one or more processors or devices.

What is claimed is:

1. A telephonic apparatus, comprising:
a switching element for transferring at least one telephone call to a selected one of a plurality of devices connected to a network, the selected device comprising a receiving element for receiving the telephone call and a sensor for reading first data from a mobile element;
an interface for receiving from the selected device the first data, and second data concerning the sensor via the network; and
a processing element configured to take an action based on the received first and second data.

2. The apparatus of claim 1 wherein the sensor is an NFC reader.

3. The apparatus of claim 2 wherein the mobile element is passive RFID tag.

4. The apparatus of claim 1 wherein the sensor is an active RFID tag reader.

5. The apparatus of claim 4 wherein the mobile element is a battery-powered RFID tag.

6. The apparatus of claim 1 wherein the second data is associated with a location of the selected device.

7. The apparatus of claim 1 wherein the first data indicates a person or an object.

8. The apparatus of claim 7 wherein the first data indicates a person, and the action causes reconfiguring the selected device based on preferences specified by the person.

9. The apparatus of claim 1 comprising a PBX.

10. A telephonic system, comprising:
a plurality of telephonic devices connected to a network, at least one of the telephonic devices comprising a sensor for reading first data from a mobile element;
a platform for processing telephone calls at least from outside of the system, selected ones of the telephone calls being receivable by the at least one telephonic device via the network;
an interface for receiving from the at least one telephonic device the first data, and second data concerning the sensor via the network; and
a processing element configured to take an action based on the received first and second data.

11. The system of claim 10 wherein the network comprises an IP based network.

12. The system of claim 10 wherein the network comprises a local area network.

13. The system of claim 10 wherein the at least one telephonic device is capable of multimedia communications.

14. The system of claim 10 wherein the platform includes a PBX.

15. The system of claim 10 wherein the sensor is an NFC reader.

16. The system of claim 10 wherein the sensor is an active RFID tag reader.

17. A telephonic device, comprising:
a port for connecting the telephonic device to a network to which one or more other telephonic devices are connectable, a telephone call being receivable by the telephonic device through the network;
a sensor for reading data from a mobile element; and
a processing element configured to send the first data, and second data concerning the sensor through the network.

18. The device of claim 17 further comprising a USB port, wherein the sensor is connected to the USB port.

19. The device of claim 17 wherein the sensor is an NFC reader.

20. The device of claim 17 wherein the sensor is an active RFID tag reader.
